(19) United States
(12) Patent Application Publication
(10) Pub. No.: US 2023/0159794 A1
(43) Pub. Date: May 25, 2023

(54) ADHESIVE TAPE FOR FLUID-TIGHT SEALING

(71) Applicant: Roshan Sakharkar, Nagpur (IN)

(72) Inventor: Roshan Sakharkar, Nagpur (IN)

(21) Appl. No.: 18/100,555

(22) Filed: Jan. 23, 2023

Related U.S. Application Data
(63) Continuation of application No. PCT/IN2021/050710, filed on Jul. 22, 2021.

(30) Foreign Application Priority Data
Jul. 22, 2020 (IN) 202021031308

(51) Int. Cl. C09J 7/29; B32B 7/06; B32B 7/14

(52) U.S. Cl. CPC C09J 7/29; B32B 7/06; B32B 7/14; C09J 2301/12; B32B 2405/00

(57) ABSTRACT

This invention discloses an adhesive tape, for fluid-tight sealing, and for firm grip, said adhesive tape being a four-sided adhesive tape comprising: a first strip (1) having an operative ventral adhesive surface (11, 12) and an operative dorsal non-adhesive surface (31a, 31b), and a second strip (2) comprising an operative ventral non-adhesive surface (32a, 32b) and an operative dorsal adhesive surface (21, 22); a joint (4) between said first strip (1) and said second strip (2), an operative left side (11), of the first strip (1), and an operative right side (12), of the first strip (1), configured to bend at the joint (4); an operative left side (21), of the second strip (2), and an operative right side (22), of the second strip (2), configured to bend at the joint (4).

### RELATED APPLICATIONS

This application claims priority under 35 U.S.C. § 120 to, and is a continuation of, co-pending International Application PCT/IN2021/050710, filed Jul. 22, 2021 and designating the US, which claims priority to Indian Application 202021031308, filed Jul. 22, 2020, such Indian Application also being claimed priority to under 35 U.S.C. § 119. These Indian and International applications are incorporated by reference herein in their entireties.

### FIELD

This invention relates to the field of biomedical engineering. Further, this invention relates to the field of mechanisms for sealing, in general, and adhesive tapes, in particular. Specifically, this invention relates to an adhesive tape for fluid-tight sealing.

### BACKGROUND

Personal protective equipment [PPE] covers a variety of equipment such as masks, eye protection glasses, body suits, waterproof socks, wetsuits; all of which have to be perfectly sealed at their borders or ends where they meet with skin of a user or where they meet with other PPE. This is important so as not to permit any air or water or liquid to pass from outside atmosphere to inside of the PPE or vice versa; thereby, aiming to result in an air-tight and water-tight space between skin and inside of PPE.

Such a closure provides the most effective protection.

Such equipment need perfect sealing at borders near neck, face, wrist, waist, ankles, and the like body parts; so that there is no ingress/egress of air/water.

Normal tape is either made to attach on skin or on material of such PPE. If a single adhesive tape is attached on the borders of any PPE, between skin and the equipment, it generally does not grasp the equipment firmly and tightly if the person using the PPE moves continuously. The adhesive tape, in such instances, comes off. One of the reasons is that there is just a singular linear locus of points across which adhesion is provided.

There is a need to provide a more fool-proof adhesion.

Some other applications include condom catheter which moves from position while it is being used. There is a need for equipment which can hold it in one place.

Yet other applications include condoms which move in position during sexual intercourse due to many reasons; e.g., lubrication of condom from inside, fluctuating rigidity of organ, and the like. This movement results in accumulation of condom in anterior region; because of which, there is reduced efficiency, less protection, less pleasure, and increased risk of sexually transmitted diseases. This demotivates a user from using a condom

Therefore, there is need for a device which can retain condom and condom catheter, at one place, at the base of a penis.

To seal borders of PPE, overlapping of border are done in some cases. E.g. while using hand gloves, borders are overlapped over sleeves of PPE.

In some cases, single or multiple layers of adhesive strip is overlapped over borders of PPE, raincoat, water socks, water suits, etc.; this single or multiple layers of strap of adhesive tape has weak grip over PPE and skin or between PPE and PPE because its single side of attachment and tape can be either made for skin or for PPE material.

A tightly tied mask over a face or if a border of any PPE is tightly strapped around a body at its endings; this can lead to injuries.

A double-sided adhesive tape exists and which has been used; however, this is plagued with some disadvantages; firstly, both surface or one surface out of these two cannot move; secondly, gripping over surface is weak; thirdly, these tapes cannot stick two surfaces in a perpendicular effective manner; fourthly, since PPE borders are directly exposed to outer environment—air and water leakage is highly possible.

Therefore, what is required is a new adhesive mechanism which can hold an object or PPE borders in a perpendicular manner and or hold objects or PPE in a horizontal manner; thereby, overlapping object(s) in a secure manner so that no air or water leakage is possible and PPE are become more safe, secure, and comfortable, with firm grip over object.

To hold an external condom catheter, in one place, over a penis, different methods were used. These methods include adhesive application on condom, sealant application over pubic area, and a sheath holder. These methods have their individual drawbacks; therefore, there is required a new mechanism which can hold external condom catheter effectively.

A condom is essential in preventing STD, HIV, and pregnancy. While using a condom, during sex, it accumulates over body or near glans region of penis and the border of the condom moves away from the base of the penis or pubic area. This is because of changing firmness of penis, liquid inside condom, sexual intercourse motion, long duration of intercourse. This results in more skin of penis being exposed from base of penis; thus increasing risk of STD and reducing pleasure during sex. Therefore, there is required a new mechanism which can hold the condom in place and pull it towards the base of penis and pubic area.

### SUMMARY

An object of the invention is to create a border sealing adhesive tape for personal protective equipment [PPE], wearable medical devices, and the like to make it fluid tight and air tight.

Another object of the invention is to create a mechanism which seals borders of PPE and such wearable medical devices with skin or between each other.

Yet another object of the invention is to make a perfectly removable mechanism to seal borders of PPE and such wearable medical devices with skin or between each other.

Still another objective of the invention is to protect and isolate body and skin after wearing PPE and such wearable medical devices.

Yet another objective of the invention is to create air tight and fluid tight joints or interfaces between PPE and skin, one PPE and another PPE, wearable medical devices and skin, and the like.

Still another objective of the invention is to retain/hold a condom/external condom catheter, in one place, and to pull it back by taking support from pubic area.

Yet another objective of the invention is to create a flexible, strong, and removable joining mechanism with adhesive tape, in which two surfaces, which are being joined, can move about in 360 degrees.

Still another objective of the invention is to provide a different specialised adhesive surface in one assembly; e.g. medical grade adhesive surfaces, plastic grade adhesive surfaces, and the like, in one assembly.

Yet another objective of the invention is to provide a firm, strong grip over an object by attaching its borders from outer and inner sides on one side and on skin on another side of the object which is being joined.

According to this invention, there is provided an adhesive tape, for fluid-tight sealing, and for firm grip, said adhesive tape being a four-sided adhesive tape comprising:

at least a first strip having an operative ventral adhesive surface and an operative dorsal non-adhesive surface, in that,
said operative ventral adhesive surface being divided by an imaginary locus of points, equidistant from at least one its length-wise edges, thereby forming an operative ventral left-side which is an adhesive side and an operative ventral right-side which is an adhesive side;
said operative dorsal non-adhesive surface being divided, into an operative left side and an operative right side, by the imaginary locus of points, equidistant from at least one its length-wise edge, thereby forming an operative dorsal left-side which is a non-adhesive side and an operative dorsal right-side which is a non-adhesive side;
the operative left side, of the first strip, and the operative right side, of the first strip, configured to bend at said imaginary locus of points;

at least a second strip comprising an operative ventral non-adhesive surface and an operative dorsal adhesive surface, in that,
said operative ventral non-adhesive surface being divided, into an operative left side and an operative right side, by an imaginary locus of points, equidistant from at least one of its length-wise edges, thereby forming an operative ventral left-side which is a non-adhesive side and an operative ventral right-side which is a non-adhesive side;
said operative dorsal adhesive surface being divided by the imaginary locus of points, equidistant from at least one its length-wise edge, thereby forming an operative dorsal left-side which is an adhesive side and an operative dorsal right-side which is an adhesive side; and
the operative left side, of the second strip, and the operative right side, of the second strip, configured to bend at said imaginary locus of points.

In at least an embodiment, said imaginary locus of points forms a joint between said first strip and said second strip, said joint being made of an item selected from a group of items consisting of overlapping adhesive tape, glue, mechanical retention means, and coupling means between said strips.

In at least an embodiment, said adhesive surfaces are provided with a peel-away wrapper on its adhesive sides.

In at least an embodiment, said borders of said four-side adhesive tape are not equidistant from a locus of points but are customised in shape and dimensions.

In at least an embodiment, said tape is elastic.

In at least an embodiment, said tape's starting point and ending point are joined with each other.

In at least an embodiment, one side of said operative ventral non-adhesive left side, of said second strip, corresponding to said operative dorsal adhesive side, is folded towards and stuck to one side of said operative dorsal non-adhesive left side, of said first strip, corresponding to said operative ventral adhesive side, such that:

said first strip having:
a. an operative ventral left-side, which is adhesive, and an operative ventral right-side, which is adhesive, and an imaginary locus of points dividing these two sides;
b. an operative dorsal left-side, which is adhesive, corresponding to said operative ventral left-side and an operative dorsal right-side, which is non-adhesive, corresponding to said operative ventral right-side; said second strip having:
a. an operative ventral left-side, which is adhesive, corresponding to said operative dorsal left-side and an operative ventral right-side, which is non adhesive, corresponding to said operative dorsal right-side, which is adhesive, and an imaginary locus of points dividing these two sides; and
b. an operative dorsal left-side, which is adhesive, corresponding to said operative ventral left side, which is adhesive, and an operative dorsal right-side, which is adhesive, corresponding to said ventral right-side, which is non-adhesive.

In at least an embodiment, said second strip having:
an adhesive operative dorsal right side facing the operative dorsal left-side, of said first strip, which is adhesive; and
a non-adhesive ventral right side facing the operative dorsal right side, of the first strip, which is non-adhesive.

In at least an embodiment, said joint is a width-wise expanded joint having a pre-defined width such that for said first strip, the operative ventral left-side, which is adhesive, extends from a first lateral edge of said expanded joint, and the operative ventral right-side, which is adhesive, extends from a first lateral edge of said expanded joint, in that, the outer edges of said operative ventral left-side and said operative ventral right-side are spaced apart from each other.

In at least an embodiment, said joint is a width-wise expanded joint having a pre-defined width such that for said second strip, the operative dorsal left-side, which is adhesive, extends from a second lateral edge of the expanded joint, and the operative dorsal right-side, which is adhesive, extends from second lateral edge of the expanded joint, in that, the outer edges of said operative dorsal left-side and said operative dorsal right-side are spaced apart from each other.

In at least an embodiment,
a first adhesive side, of said four-sided adhesive tape, is provided by an operative ventral side of said operative left-side, of said first strip, which has said non-adhesive operative dorsal left side;
a second adhesive side, of said four-sided adhesive tape, is provided by an operative ventral side of said operative right-side, of said first strip, which has said non-adhesive operative dorsal right side;
a third adhesive side, of said four-sided adhesive tape, is provided by an operative dorsal left side, of said first outwardly projecting side, of said second strip, which has a non-adhesive operative ventral left side; and
a fourth adhesive side, of said four-sided adhesive tape, is provided by said operative dorsal right side, of said second outwardly projecting side, of said second strip, which has a non-adhesive operative ventral right side.

In at least an embodiment, said joint is a width-wise expanded joint, said expanded joint being made of an item selected from a group of items consisting of overlapping adhesive tape, glue, mechanical retention means, and coupling means between said strips.

In at least an embodiment, said first strip is made by joining different strip(s) at another joint, hollow adhesive tube, and has turning.

In at least an embodiment, said first strip being divided by a tubing, thereby forming an operative ventral left-side, which is adhesive, and an operative ventral right-side, which is adhesive, said tubing being an expanded extruded joint where its ventral surface is spaced apart from its dorsal surface to form a hollow, therebetween, the operative dorsal side of said first strip, which is a non-adhesive side, is divided by said hollow tubing such that:
said operative left-side's operative ventral side is an adhesive side and its operative dorsal left side is a non-adhesive side;
said operative right-side's operative ventral side is an adhesive side and its operative dorsal right side is a non-adhesive side; and
said operative left side, of said first strip, and said operative right side, of said first strip, bends at said tubing.

In at least an embodiment, said second strip, having an operative ventral non-adhesive left-side surface and an operative ventral non-adhesive right-side surface and operative dorsal adhesive surfaces, said second strip being divided by a hollow adhesive tubing, thereby forming an operative dorsal left-side, which is adhesive, and an operative dorsal right-side, which is adhesive, said operative ventral side of said second strip, which is a non-adhesive side, is divided into left and right by said hollow tubing such that:
said operative left-side's operative dorsal side is an adhesive side and its operative ventral left-side is a non-adhesive side;
said operative right-side's operative dorsal side is an adhesive side and its operative ventral right-side is a non-adhesive side; and
said operative left side, of the second strip, and the operative right side, of the second strip, can bend at hollow adhesive tubing.

In at least an embodiment said first strip and said second strip has an adhesive turning which is located at a joint between these two strips.

In at least an embodiment, said tape comprises a single adhesive hollow joint, between said first strip and said second strip, instead of two hollow joints between them.

### BRIEF DESCRIPTION OF THE DRAWINGS

The invention will now be described in relation to the accompanying drawings in which:

FIG. 1 illustrates an isometric view of four-sided adhesive tape;

FIG. 2 illustrates a cross section of the four-sided adhesive tape of FIG. 1;

FIG. 3 illustrates a four-sided adhesive tape in which two of its sides are attached to each other on their non-adhesive back side;

FIG. 4 illustrates a cross section of the four-sided adhesive tape, of FIG. 3, in which two of its non-adhesive sides are attached to each other;

FIG. 5 illustrates the four-sided adhesive tape, of FIG. 1, with an additional expanded joint;

FIG. 6 illustrates a cross section of the four-sided adhesive tape with expanded joint of FIG. 5;

FIG. 7 illustrates a two-sided adhesive tape, with extended tubular joint between them, in order to hold nasal prongs of an oxygen tube in its place;

FIG. 8 illustrates a cross section of the assembly of FIG. 7;

FIG. 9 illustrates cross section of a face mask, in position, before attachment, with the four-sided adhesive tape of FIG. 1 and FIG. 2;

FIG. 10 illustrates a cross section of a water proof sock in position before attachment with the four-sided adhesive tape in which two non-adhesive sides are attached to each other as shown in FIG. 3 and FIG. 4; and

FIG. 11 illustrates a cross section of a condom, in position, before attachment with the four-sided adhesive tape in which two non-adhesive sides are attached to each other as shown in FIG. 3 and FIG. 4.

### DETAILED DESCRIPTION

According to this invention, there is provided an adhesive tape for fluid-tight sealing and for firm grip.

Typically, this adhesive tape is configured to provide air tight and water tight sealing of borders of personal protective equipment [PPE] with respect to underlying skin, with respect to other PPE, or with respect to medical devices.

Typically, the invention is a multi-sided adhesive tape for sealing borders, in an air-tight and water-tight manner, with a firm grip, the borders being the borders of personal protective equipment [PPE] with respect to underlying skin of a user or underlying personal protective equipment [PPE] and/or medical devices with respect to underlying skin of a user or underlying personal protective equipment [PPE].

Typically, the invention is a multi-sided adhesive tape for holding, a condom/an external condom catheter, in one place by providing firm grip, over the condom/the external condom catheter, on one side and on base of penis and on pubic area on another side.

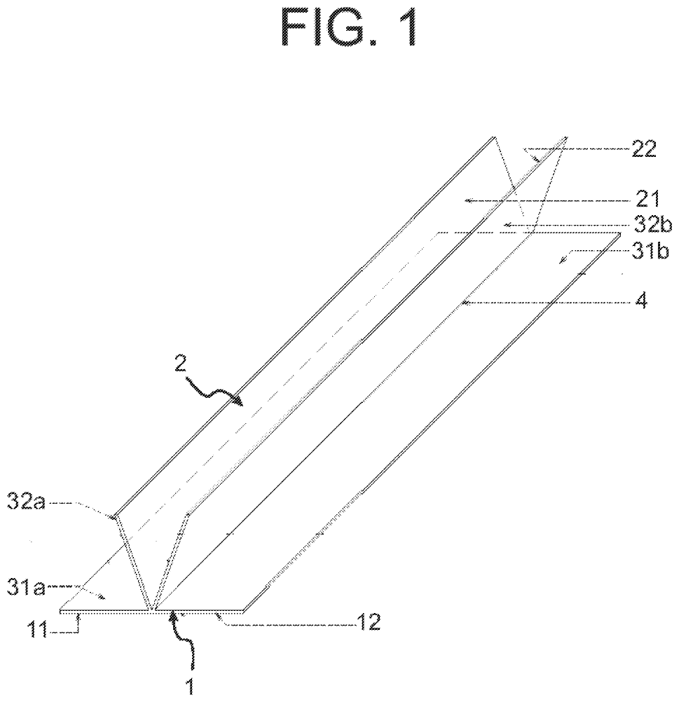

FIG. 1 illustrates an isometric view of four-sided adhesive tape.

In at least an embodiment, the invention discloses a four-sided adhesive tape, in that, said adhesive tape comprises at least a first strip (1) comprising an operative ventral adhesive surface (11, 12) and an operative dorsal non-adhesive surface (31a, 31b). The first strip (1) is divided by an imaginary locus of points (4) equidistant from at least one its length-wise edges, thereby forming an operative ventral left-side (11) which is adhesive and an operative ventral right-side (12) which is adhesive. The operative dorsal side (31a, 31b) of the first strip which is a non-adhesive side is also divided by the imaginary locus of points (4) equidistant from at least one its length-wise edges. Thus, the operative left-side's (11) operative ventral side is an adhesive side and its operative dorsal left side (31a) is a non-adhesive side. Thus, the operative right-side's (12) operative ventral side is an adhesive side and its operative dorsal right side (31b) is a non-adhesive side. The operative left side (11), of the first strip (1), and the operative right side (12), of the first strip (1), can bend at the imaginary locus of points (4).

In at least an embodiment, the invention discloses a four-sided adhesive tape, in that, said adhesive tape comprises at least a second strip (2) comprising an operative ventral non-adhesive surface (32a, 32b) and an operative dorsal adhesive surface (21, 22). The second strip (2) is divided by an imaginary locus of points (4) equidistant from at least one of its length-wise edges, thereby forming an operative dorsal left-side (21) which is adhesive and an operative dorsal right-side (22) which is adhesive. The operative ventral side (32a, 32b) of the second strip which is a non-adhesive side is also divided by the imaginary locus of points (4) equidistant from at least one its length-wise edges. Thus, the operative left-side's (21) operative dorsal side is an adhesive side and its operative ventral left side (32a) is a non-adhesive side. Thus, the operative right-side's (22) operative dorsal side is an adhesive side and its operative ventral right side (32b) is a non-adhesive side. The operative left side (21), of the second strip (2), and the operative right side (22), of the second strip (2), can bend at the imaginary locus of points (4).

In at least an embodiment, the imaginary locus of points is a joint (4) between the first strip (1) and the second strip (2). This can be made of overlapping adhesive tape or glue or by means of mechanical retention or by any such sort of coupling between the strips. This joint is a leak-proof, water-proof, air-proof joint.

In at least an embodiment, the adhesive surfaces are provided with a peel-away wrapper.

In at least an embodiment, the borders of the four-side adhesive tape are not equidistant from a locus of points but are customised in shape and dimensions.

In at least an embodiment this assembly is elastic.

In at least an embodiment this assembly, the starting and ending point are joined with each other.

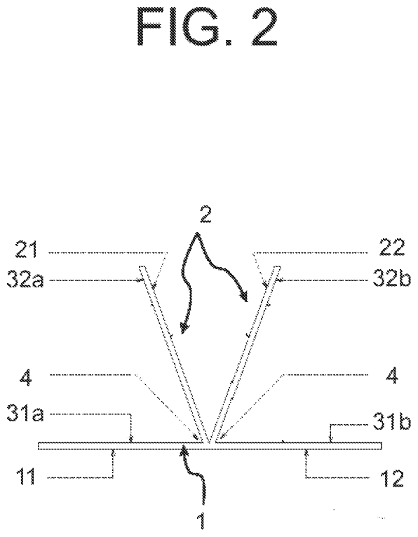

FIG. 2 illustrates a cross section of the four-sided adhesive tape of FIG. 1.

In at least an embodiment, each of the adhesive surfaces is such that they can stick to a skin surface, PPE surface, or medical equipment surface.

In the embodiment depicted by FIG. 1 and FIG. 2, a first adhesive side of the four-sided adhesive tape is provided by the operative ventral side of the operative left-side (11) of the first strip (1) which has non adhesive operative dorsal left-side (31a), a second adhesive side of the four sided adhesive tape is provided by the operative ventral side of the operative right-side (12) of the first strip (1) which has a non adhesive operative dorsal right-side (31b), a third adhesive side of the four-sided adhesive tape is provided by the operative dorsal left side (21) of the first outwardly projecting side (21) of the second strip (2) which has a non-adhesive operative ventral left side (32a), and a fourth adhesive side of the four-sided adhesive tape is provided by the operative dorsal right side (22) of the second outwardly projecting side (22) of the second strip (2) which has a non-adhesive operative ventral right side (32b).

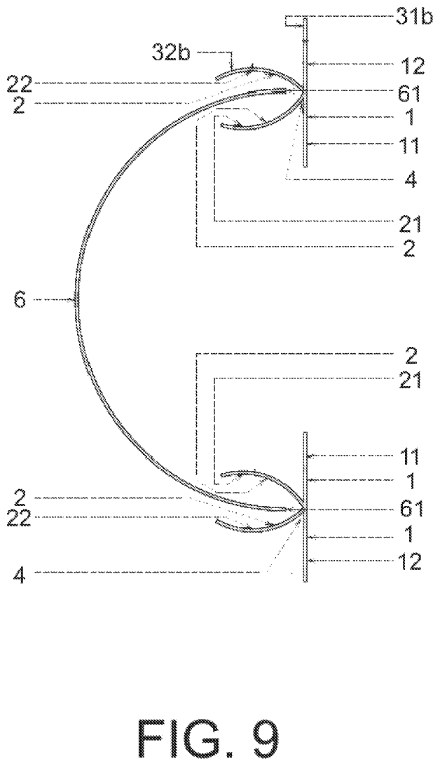

FIG. 9 illustrates cross section of a face mask, in position, before attachment, with the four-sided adhesive tape of FIG. 1 and FIG. 2.

A face mask, when fixed on a person's face, does not provide the opportunity for a perfect seal with respect to the skin that it is in contact with due to the curved contouring of a person's face; especially using traditional adhesive mechanisms/tapes. Therefore, there is always a possibility of air leakage and fluid leakage. This leakage may be harmful as leaked air or fluid is unfiltered.

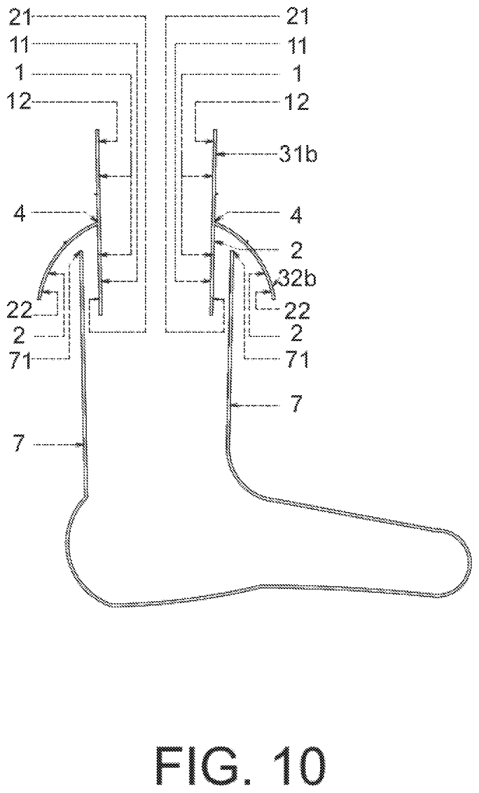

This invention's adhesive tape arrests these limitations as seen in FIGS. 9 and 10 of the accompanying drawings.

As seen in FIG. 9, the operative ventral left-side (11), which is adhesive, and the operative ventral right-side (12), which is adhesive, are both customised and fit on a face of a person.

As seen in FIG. 9, the first outwardly projecting operative dorsal left-side (21), which is adhesive, and the operative dorsal right-side (22), which is adhesive, are both customised such that they effectively stick and adhere on to borders (61) of a face mask material (6).

This invention's adhesive tape ensures that it will hold the face mask (6) firmly using the corresponding adhesive surfaces of the first strip (1) and using the corresponding adhesive surfaces of the second strip (2).

The first strip (1) and the second strip (2) are joined with each other at the joint (4) from their non adhesive surface (31a, 31b, 32a, 32b).

The operative dorsal non adhesive surface (31a, 31b) of the first strip and the operative ventral non-adhesive surface (32a, 32b) of the second strip; both are joined at the joint (4).

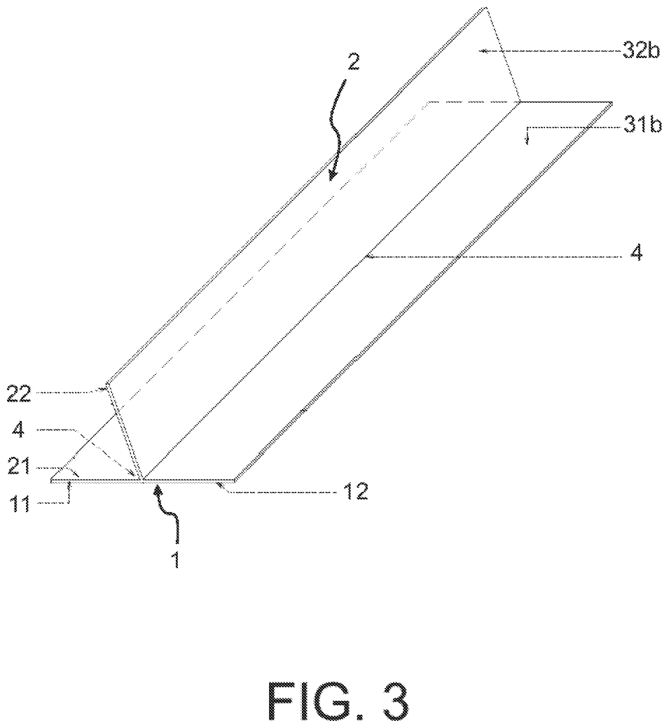

FIG. 3 illustrates four-sided adhesive tape in which two of its sides are attached to each other on their non-adhesive back side.

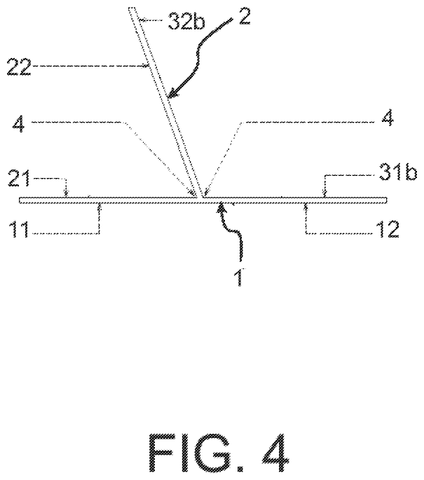

FIG. 4 illustrates a cross section of the four-sided adhesive tape, of FIG. 3, in which two of its non-adhesive sides are attached to each other.

In at least an embodiment, one side of the operative ventral non-adhesive left side (32a) of the second strip (2), which is corresponding to adhesive side (21), is folded towards and stuck to the one side of the operative dorsal left side (31a) of the first strip (1), which is corresponding to adhesive side (11).

This assembly, of FIG. 3 and FIG. 4, now has a first strip (1) with an operative ventral left-side (11) which is adhesive and an operative ventral right-side (12) which is adhesive; an imaginary locus of points (4) divides these two sides.

Further, this assembly, of FIG. 3 and FIG. 4, now has a first strip (1) with an operative dorsal left-side (21) which is adhesive and an operative dorsal right-side (31b) which is non-adhesive.

Further, this assembly, of FIG. 3 and FIG. 4, now has a second strip (2) with an operative dorsal adhesive right side (22) facing the operative dorsal adhesive left-side (21), of the first strip (1), which is adhesive.

Further, this assembly, of FIG. 3 and FIG. 4, now has a second strip (2) with an operative ventral non-adhesive right side (32b) facing the operative dorsal right side (31b), of the first strip (1), which is non-adhesive.

In at least an embodiment, the adhesive surfaces are provided with a peel-away wrapper.

In at least an embodiment this assembly is elastic.

In at least an embodiment of this assembly, the starting and ending point are joined with each other.

FIG. 10 illustrates a vertical cross section of water proof socks in position before attachment with the four-sided adhesive tape in which two non-adhesive sides are attached to each other as shown in FIG. 3 and FIG. 4.

Water socks are water proof—so, it helps to keep feet dry when water comes in contact. Borders (71) of water socks (7) where it meets with skin are not water tight and air tight. Thus, water may enter through these borders (71) and make feet wet. For making borders leakage proof, the adhesive tape of this invention is used; this tape seals borders and stops allowing entry of water and air into the water socks.

A vertical cross section of water socks (7) shows its shape. Borders or entry and exit opening (71) of water socks (7) is shown in close proximity with the adhesive tape, as shown in FIGS. 3 and 4, of this invention. This adhesive tape is fixed on water socks in such a way that the border (71) of socks is not exposed making it a water tight and air tight.

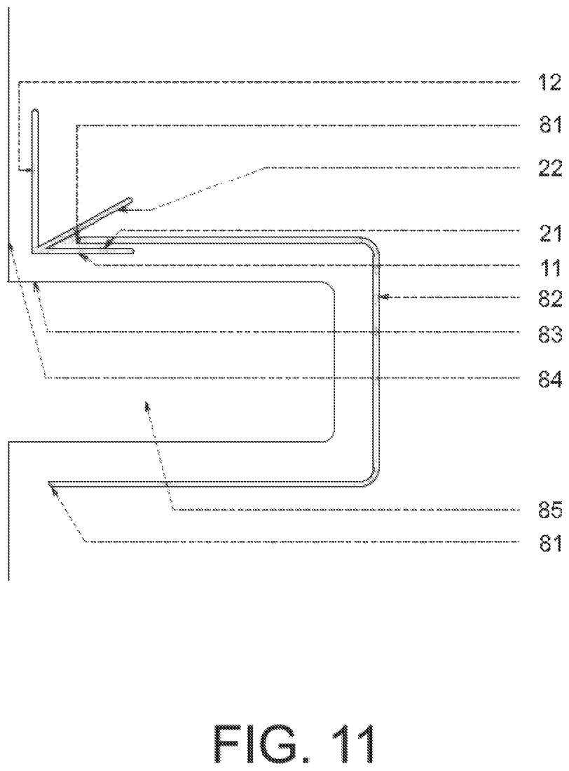

FIG. 11 illustrates a cross section of a condom, in position, before attachment with the four-sided adhesive tape, of this invention, in which two non-adhesive sides are attached to each other as shown in FIG. 3 and FIG. 4.

Symbolic representation of a condom (82) is shown over a penis (85). The figure also shows a border of the condom (81) which should, ideally, be in close proximity of a pubic area (84) and a condom should cover the base (83) of the penis (85).

The four-sided adhesive tape, of this invention, is useful in such a tricky area, where penis can move in 180 degrees with respect to pubic area surface.

The adhesive side (12), of the four-sided adhesive tape, of this invention, attaches on to the pubic area (84) and the adhesive side (11), of the four-sided adhesive tape, of this invention, attaches on to a base (83) of the penis (85).

The adhesive sides (21, 22), of the four-sided adhesive tape, of this invention, attaches and holds the border of the condom (81). There is no need to encircle the penis (85) with the four-sided adhesive tape, of this invention, since one needs to only keep the border of the condom (81) near the pubic area (84) by covering the base (83) of the penis with the condom (82).

The four-sided adhesive tape, of this invention, provides a firm grip over the border of the condom (81), on one side, and at the base of the penis (83) and the pubic area (84) on the other side.

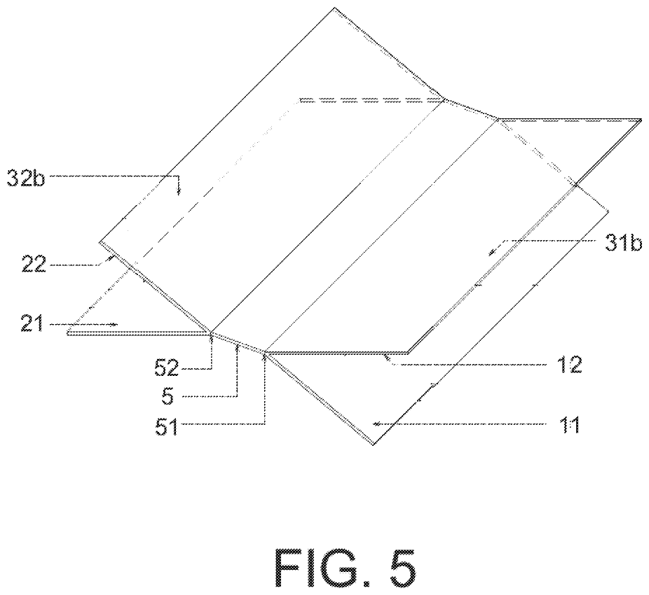

FIG. 5 illustrates the four-sided adhesive tape, of FIG. 1, with an additional expanded joint.

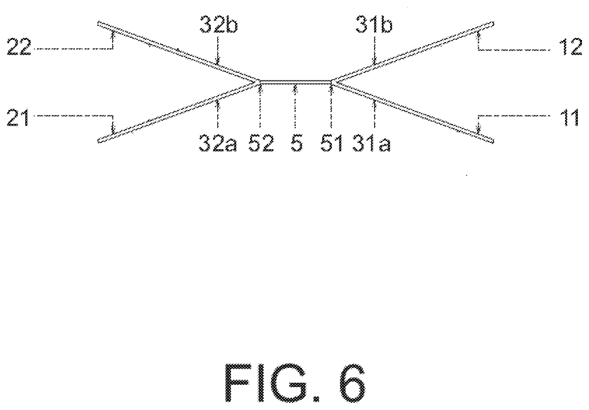

FIG. 6 illustrates a cross section of the four-sided adhesive tape with expanded joint of FIG. 5.

In at least an embodiment, the joint (4) is a width-wise expanded joint (5) having a pre-defined width such that for first strip, the operative ventral left-side (11) which is adhesive extends from a first lateral edge (51) of the extruded joint (5) and the operative ventral right-side (12) which is adhesive also extends from a first lateral edge (51) of the extruded joint (5), in that, the outer edges of the operative ventral left-side (11) and the operative ventral right-side (12) are spaced apart from each other.

In at least an embodiment, the joint (4) is a width-wise expanded joint (5) having a pre-defined width such that for second strip, the operative dorsal left-side (21) which is adhesive extends from a second lateral edge (52) of the extruded joint (5) and the operative dorsal right-side (22) which is adhesive also extends from second lateral edge (52) of the extruded joint (5), in that, the outer edges of the operative dorsal left-side (21) and the operative dorsal right-side (22) are spaced apart from each other.

A non-adhesive back side of (21, 22) is depicted by reference numerals 32a and 32b, respectively.

A non-adhesive back of side 11 and side 12 is depicted by reference numeral 31a and 31b, respectively.

In at least an embodiment, the expanded joint (5) which can be made of glue or by means of mechanical retention or by overlapping adhesive tape or by any such sort of coupling between the strips (1, 2). This joint is a leak-proof, water-proof, air-proof joint.

In at least an embodiment, the adhesive surfaces are covered with paper or foil or other non-sticky surface so that it can be removed just before using.

In at least one embodiment, this entire tape is elastic or resilient in nature.

In at least an embodiment of this assembly, the starting and ending point are joined with each other.

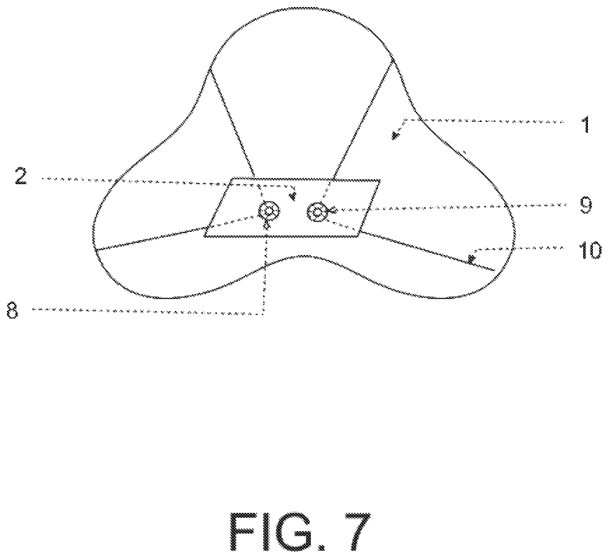

FIG. 7 illustrates a four-sided adhesive tape, with extended tubular joint between them, in order to hold nasal prongs of an oxygen tube in its place.

In at least an embodiment, the first strip (1) is designed and shaped to be stuck on a user's face covering their nose with nasal prongs fitted in the nose and a second strip (2) is designed and shaped to be stick on a nasal oxygen tube and a hollow tubing (8) is designed and shaped to be stuck on the nasal prongs of the oxygen tubing. The first strip (1) can be made by joining different strip(s) at joint (10), hollow adhesive tube (8), and has turning (9).

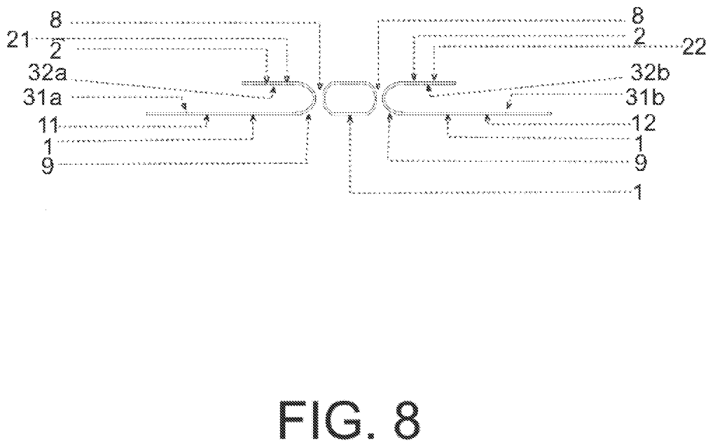

FIG. 8 illustrates a cross section of the assembly of FIG. 7.

In at least an embodiment, the invention discloses a four-sided adhesive tape, in that, said adhesive tape comprises at least a first strip (1) comprising operative ventral adhesive surfaces (11, 12) and an operative dorsal non-adhesive surface (31a, 31b). The first strip (1) is divided by a tubing (8), thereby forming an operative ventral left-side (11) which is adhesive and an operative ventral right-side (12) which is adhesive. Typically, the tubing (8) is an expanded extruded joint (5) where its ventral surface is spaced apart from its dorsal surface to form a hollow, therebetween. The operative dorsal side (31a, 31b) of the first strip which is a non-adhesive side is also divided by this hollow tubing (8). Thus, the operative left-side's (11) operative ventral side is an adhesive side and its operative dorsal side (31a) is a non-adhesive side. Thus, the operative right-side's (12) operative ventral side is an adhesive side and its operative dorsal side (31b) is a non-adhesive side. The operative left side (11), of the first strip (1), and the operative right side (12), of the first strip (1), can bend at the tubing (8).

In at least an embodiment, the invention discloses a four-sided adhesive tape, in that, said adhesive tape comprises at least a second strip (2) comprising an operative ventral non-adhesive surface (32a, 32b) and operative dorsal adhesive surfaces (21, 22). The second strip (2) is divided by the hollow adhesive tubing (8), thereby forming an operative dorsal left-side (21) which is adhesive and an operative dorsal right-side (22) which is adhesive. The operative ventral side (32a, 32b) of the second strip which is a non-adhesive side is also divided by hollow tubing (8). Thus, the operative left-side's (21) operative dorsal side is an adhesive side and its operative ventral side (32a) is a non-adhesive side. Thus, the operative right-side's (22) operative dorsal side is an adhesive side and its operative ventral side (32b) is a non-adhesive side. The operative left side (21), of the second strip (2), and the operative right side (22), of the second strip (2), can bend at hollow adhesive tubing (8).

In at least an embodiment, first strip (1) and second strip (2) has an adhesive turning (9).

In at least an embodiment, there is a single adhesive hollow joint (8), between first strip (1) and second strip (2), instead of two hollow joints between them.

In at least an embodiment, the adhesive surfaces are provided with a peel-away wrapper.

In at least an embodiment, the borders of the four-side adhesive tape are not equidistant from a locus of points, tubing (8) but are customised in shape and dimensions.

In at least an embodiment this assembly is elastic.

This arrangement of adhesive/sticky surface as shown in FIG. 7 and FIG. 8 is made for fixing nasal prongs of oxygen tube into nostrils with no leakage of air or liquid. Such arrangement makes it possible to induce oxygen with more pressure into nose.

The technical advancement of this invention lies in providing an adhesive tape for fluid-tight and air tight sealing. This invention can provide four adhesive sides to hold an object with skin for firm grip. This can hold objects, devices, or PPE borders in a perpendicular manner with respect to an underlying skin of a user. Its two adhesive sides stick on outer and inner surface on border/s of PPE/object/device and remaining two surfaces attaches on to skin, tricky areas of body (e.g. face, pubic area, another border of PPE, object, device) giving a firm grip. Two objects attached, with the adhesive tape of invention, can move in 360 degree without detachment. This adhesive tape exposes only one border of each side in order to remove adhesive tape and other border of each individual side is embedded in a joint with other adhesive side. This arrangement joins two objects with more strength than existing single and double tape. It also joins borders of two PPE or PPE and Medical device. It also holds objects, devices, or PPE borders in a horizontal manner, thereby, overlapping object(s) in a secure manner so that no air, water, of fluid leakage is possible and so that PPE becomes relatively more safe, relatively more secure, relatively more reliable, and relatively more comfortable.

While this detailed description has disclosed certain specific embodiments for illustrative purposes, various modifications will be apparent to those skilled in the art which do not constitute departures from the spirit and scope of the invention as defined in the following claims, and it is to be distinctly understood that the foregoing descriptive matter is to be interpreted merely as illustrative of the invention and not as a limitation.

1. An adhesive tape, for fluid-tight sealing, and for firm grip, said adhesive tape being a four-sided adhesive tape comprising:
at least a first strip (1) having an operative ventral adhesive surface (11, 12) and an operative dorsal non-adhesive surface (31a, 31b), in that,
said operative ventral adhesive surface (11, 12) being divided by an imaginary locus of points (4), equidistant from at least one its length-wise edges, thereby forming an operative ventral left-side (11) which is an adhesive side and an operative ventral right-side (12) which is an adhesive side;
said operative dorsal non-adhesive surface (31a, 31b) being divided, into an operative left side (31a) and an operative right side (31b), by the imaginary locus of points (4), equidistant from at least one its length-wise edge, thereby forming an operative dorsal left-side (31a) which is a non-adhesive side and an operative dorsal right-side (31b) which is a non-adhesive side;
the operative left side (11), of the first strip (1), and the operative right side (12), of the first strip (1), configured to bend at said imaginary locus of points (4);
at least a second strip (2) comprising an operative ventral non-adhesive surface (32a, 32b) and an operative dorsal adhesive surface (21, 22), in that,
said operative ventral non-adhesive surface (32a, 32b) being divided, into an operative left side (32a) and an operative right side (32b), by an imaginary locus of points (4), equidistant from at least one of its length-wise edges, thereby forming an operative ventral left-side (32a) which is a non-adhesive side and an operative ventral right-side (32b) which is a non-adhesive side;
said operative dorsal adhesive surface (21, 22) being divided by the imaginary locus of points (4), equidistant from at least one its length-wise edge, thereby forming an operative dorsal left-side (21) which is an adhesive side and an operative dorsal right-side (22) which is an adhesive side; and
the operative left side (21), of the second strip (2), and the operative right side (22), of the second strip (2), configured to bend at said imaginary locus of points (4).

2. The adhesive tape as claimed in claim 1 wherein, said imaginary locus of points forms a joint (4) between said first strip (1) and said second strip (2), said joint (4) being made of an item selected from a group of items consisting of overlapping adhesive tape, glue, mechanical retention means, and coupling means between said strips.

3. The adhesive tape as claimed in claim 1 wherein, said adhesive surfaces are provided with a peel-away wrapper on its adhesive sides.

4. The adhesive tape as claimed in claim 1 wherein, said borders of said four-side adhesive tape are not equidistant from a locus of points but are customised in shape and dimensions.

5. The adhesive tape as claimed in claim 1 wherein, said tape is elastic.

6. The adhesive tape as claimed in claim 1 wherein, said tape's starting point and ending point are joined with each other.

7. The adhesive tape as claimed in claim 1 wherein, one side of said operative ventral non-adhesive left side (32a), of said second strip (2), corresponding to said operative dorsal adhesive side (21), is folded towards and stuck to one side of said operative dorsal non-adhesive left side (31a), of said first strip (1), corresponding to said operative ventral adhesive side (11), such that:
said first strip (1) having:
a. an operative ventral left-side (11), which is adhesive, and an operative ventral right-side (12), which is adhesive, and an imaginary locus of points (4) dividing these two sides;
b. an operative dorsal left-side (21), which is adhesive, corresponding to said operative ventral left-side (11) and an operative dorsal right-side (31b), which is non-adhesive, corresponding to said operative ventral right-side (12);
said second strip (2) having:
a. an operative ventral left-side (11), which is adhesive, corresponding to said operative dorsal left-side (21) and an operative ventral right-side (32b), which is non adhesive, corresponding to said operative dorsal right-side (22), which is adhesive, and an imaginary locus of points (4) dividing these two sides; and
b. an operative dorsal left-side (21), which is adhesive, corresponding to said operative ventral left side (11), which is adhesive, and an operative dorsal right-side (22), which is adhesive, corresponding to said ventral right-side (32b), which is non-adhesive.

8. The adhesive tape as claimed in claim 7 wherein, said second strip (2) having:
an adhesive operative dorsal right side (22) facing the operative dorsal left-side (21), of said first strip (1), which is adhesive; and
a non-adhesive ventral right side (32b) facing the operative dorsal right side (31b), of the first strip (1), which is non-adhesive.

9. The adhesive tape as claimed in claim 1 wherein, said joint (4) is a width-wise expanded joint (5) having a pre-defined width such that for said first strip, the operative ventral left-side (11), which is adhesive, extends from a first lateral edge (51) of said expanded joint (5), and the operative ventral right-side (12), which is adhesive, extends from a first lateral edge (51) of said expanded joint (5), in that, the outer edges of said operative ventral left-side (11) and said operative ventral right-side (12) are spaced apart from each other.

10. The adhesive tape as claimed in claim 1 wherein, said joint (4) is a width-wise expanded joint (5) having a pre-defined width such that for said second strip, the operative dorsal left-side (21), which is adhesive, extends from a second lateral edge (52) of the expanded joint (5), and the operative dorsal right-side (22), which is adhesive, extends from second lateral edge (52) of the expanded joint (5), in that, the outer edges of said operative dorsal left-side (21) and said operative dorsal right-side (22) are spaced apart from each other.

11. The adhesive tape as claimed in claim 1 wherein,
a first adhesive side, of said four-sided adhesive tape, is provided by an operative ventral side of said operative left-side (11), of said first strip (1), which has said non-adhesive operative dorsal left side (31a);
a second adhesive side, of said four-sided adhesive tape, is provided by an operative ventral side of said operative right-side (12), of said first strip (1), which has said non-adhesive operative dorsal right side (31b);
a third adhesive side, of said four-sided adhesive tape, is provided by an operative dorsal left side (21), of said first outwardly projecting side (21), of said second strip (2), which has a non-adhesive operative ventral left side (32a); and
a fourth adhesive side, of said four-sided adhesive tape, is provided by said operative dorsal right side (22), of said second outwardly projecting side (22), of said second strip (2), which has a non-adhesive operative ventral right side (32b).

12. The adhesive tape as claimed in claim 1 wherein, said joint (4) is a width-wise expanded joint (5), said expanded joint (5) being made of an item selected from a group of items consisting of overlapping adhesive tape, glue, mechanical retention means, and coupling means between said strips.

13. The adhesive tape as claimed in claim 1 wherein, said first strip (1) is made by joining different strip(s) at another joint (10), hollow adhesive tube (8), and has turning (9).

14. The adhesive tape as claimed in claim 1 wherein, said first strip (1) being divided by a tubing (8), thereby forming an operative ventral left-side (11), which is adhesive, and an operative ventral right-side (12), which is adhesive, said tubing (8) being an expanded extruded joint (5) where its ventral surface is spaced apart from its dorsal surface to form a hollow, therebetween, the operative dorsal side (31a, 31b) of said first strip, which is a non-adhesive side, is divided by said hollow tubing (8) such that:
said operative left-side's (11) operative ventral side is an adhesive side and its operative dorsal left side (31a) is a non-adhesive side;
said operative right-side's (12) operative ventral side is an adhesive side and its operative dorsal right side (31b) is a non-adhesive side; and
said operative left side (11), of said first strip (1), and said operative right side (12), of said first strip (1), bends at said tubing (8).

15. The adhesive tape as claimed in claim 1 wherein, said second strip (2), having an operative ventral non-adhesive left-side surface (32a) and an operative ventral non-adhesive right-side surface (32b) and operative dorsal adhesive surfaces (21, 22), said second strip (2) being divided by a hollow adhesive tubing (8), thereby forming an operative dorsal left-side (21), which is adhesive, and an operative dorsal right-side (22), which is adhesive, said operative ventral side (32a, 32b) of said second strip, which is a non-adhesive side, is divided into left and right by said hollow tubing (8) such that:
said operative left-side's (21) operative dorsal side is an adhesive side and its operative ventral left-side (32a) is a non-adhesive side;
said operative right-side's (22) operative dorsal side is an adhesive side and its operative ventral right-side (32b) is a non-adhesive side; and
said operative left side (21), of the second strip (2), and the operative right side (22), of the second strip (2), can bend at hollow adhesive tubing (8).

16. The adhesive tape as claimed in claim 1 wherein, said first strip (1) and said second strip (2) has an adhesive turning (9) which is located at a joint between these two strips (1, 2).

17. The adhesive tape as claimed in claim 1 wherein, said tape comprising a single adhesive hollow joint (8), between said first strip (1) and said second strip (2), instead of two hollow joints between them.
